(19) United States
(12) Patent Application Publication
(10) Pub. No.: US 2015/0086959 A1
(43) Pub. Date: Mar. 26, 2015

(54) Ultrasound Loop Control

(71) Applicants: Richard Hoppmann, Columbia, SC (US); Debra Krotish, Blythewood, SC (US); Michael S. Riffle, Swansea, SC (US); Victor Rao, Columbia, SC (US); Stephen Harris, Cayce, SC (US); Duncan Howe, Hopkins, SC (US); Mary Elizabeth Poston, Columbia, SC (US)

(72) Inventors: Richard Hoppmann, Columbia, SC (US); Debra Krotish, Blythewood, SC (US); Michael S. Riffle, Swansea, SC (US); Victor Rao, Columbia, SC (US); Stephen Harris, Cayce, SC (US); Duncan Howe, Hopkins, SC (US); Mary Elizabeth Poston, Columbia, SC (US)

(21) Appl. No.: 14/496,025

(22) Filed: Sep. 25, 2014

Related U.S. Application Data
(60) Provisional application No. 61/882,704, filed on Sep. 26, 2013.

(51) Int. Cl. G09B 23/28

(52) U.S. Cl. CPC G09B 23/286
USPC 434/272

(57) ABSTRACT

A method for conducting ultrasonography training using ultrasound loop control may generally include providing for display a moving ultrasound image of an internal body part, wherein the moving ultrasound image is associated with an image frame loop including a plurality of individual image frames. The method may also include receiving an initial input from a user associated with stopping the moving ultrasound image at a current image frame of the image frame loop, receiving a second input associated with cycling forward or backwards through the image frame loop in order to provide additional image frames of the image frame loop for display to the user and receiving a third input associated with a submission of one of the image frames as a selected image frame.

### FIELD OF THE INVENTION

The present subject matter relates generally to ultrasonography training and, more particularly, to systems and methods for conducting ultrasonography training using ultrasound loop control.

### BACKGROUND OF THE INVENTION

Ultrasonography training is typically performed by trainees practicing on live patients and then learning disease processes from mentors. The current approach to training in ultrasonography generally utilizes classroom training and education in the theory and physics of ultrasound measurements. Once this is completed the trainee goes through extended on the job training by practicing and learning on real patients under the guidance of an experienced radiologist.

Presently available ultrasonography training is provided with models that may not be realistic and certainly are limited by the number and expense of multiple models with which to train. Thus, it is desirable to provide an ultrasonography training system and related method that permits the trainee to view more images of particular areas of interest for specialization and for improving training.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for conducting ultrasonography training using ultrasound loop control. The method may generally include providing for display a moving ultrasound image of an internal body part, wherein the moving ultrasound image is associated with an image frame loop including a plurality of individual image frames. The method may also include receiving an initial input from a user associated with stopping the moving ultrasound image at a current image frame of the image frame loop, receiving a second input associated with cycling forward or backwards through the image frame loop in order to provide additional image frames of the image frame loop for display to the user and receiving a third input associated with a submission of one of the image frames as a selected image frame.

In another aspect, the present subject matter is directed to a system for conducting ultrasonography training using ultrasound loop control. The system may generally include a display and a computing device coupled to the display. The computing device may include a processor and associated memory. The memory may store instructions that, when implemented by the processor, configure the computing device to provide for display a moving ultrasound image of an internal body part, wherein the moving ultrasound image is associated with an image frame loop including a plurality of individual image frames. In addition, the computing device may be configured to receive an initial input from a user associated with stopping the moving ultrasound image at a current image frame of the image frame loop, receive a second input associated with cycling forward or backwards through the image frame loop in order to provide additional image frames of the image frame loop for display to the user and receive a third input associated with a submission of one of the image frames as a selected image frame.

Other exemplary aspects of the present disclosure are directed to devices, systems, and methods for conducting ultrasonography training

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified view of an example training environment within which the present subject matter may be advantageously utilized in accordance with aspects of the present subject matter;

FIG. 2 illustrates an example view of an image frame loop for a moving ultrasound image in accordance with aspects of the present subject matter;

FIG. 3 illustrates an example view of one embodiment of a suitable user interface that may be displayed to a trainee viewing a moving ultrasound image as part of a computer-based, training methodology in accordance with aspects of the present subject matter;

FIG. 4 illustrates a schematic diagram of one embodiment of various components that may be included within or coupled to an ultrasound training device of the disclosed system in accordance with aspects of the present subject matter; and

FIG. 5 illustrates a flow diagram of one embodiment of a method for conducting ultrasonography training using ultrasound loop control.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for conducting ultrasonography training using ultrasound loop control. Specifically, as part of a computer-based program to teach clinical ultrasound skills, the present disclosure describes a system and method that allows a moving ultrasound image loop to be paused or stopped to allow the viewer (e.g., a healthcare learner or trainee) to adjust the image loop frames backward or forward to select a specific frame in the appropriate phase of the movement cycle for clinical assessment, e.g. identification of a specific organ part and/or to take a measurement of a specific organ component seen in the ultrasound image loop. The viewer may then submit the selected frame to be evaluated by an associated assessment module, which determines whether the selected frame corresponds to the correct frame (or falls within a range of appropriate frames). Additionally, the viewer may receive immediate feedback from the assessment module as to correctness of the submitted image frame for purposes of interactive learning or self-assessment. In a similar manner, the answer submitted by the viewer may also be graded for purposes of course testing or certification.

It should be appreciated by those of ordinary skill in the art that clinical ultrasound skills—especially measurement of a specific organ component or identification of cycle phases—are typically acquired one-on-one between a healthcare professional and a healthcare learner or trainee. However, the present subject matter allows healthcare trainees to practice needed clinical skills in ultrasound on their own—taking as much time as each student needs—through computer-based, active learning. This self-paced, interactive methodology is new and more advantageous than traditional one-on-one teaching of medical skills.

Additionally, it should be appreciated that, when using ultrasound for clinical assessment, it is often necessary to accurately measure a structure at the appropriate point in a cycle, such as the cardiac cycle or during pulsations of a vessel. An example is the accurate measurement of the heart wall thickness as a means to assess ventricular hypertrophy in patients with a history of hypertension. Unfortunately, the teaching of this skill to a healthcare trainee is often difficult. The presently disclosed technology enables trainees of clinical ultrasound to acquire structure identification, movement cycle phases, and measurement skills through interactive learning on a computer-based platform (including tablets, smart phones, and apps). Moreover, the technology may also be utilized for computer-based course testing or certification.

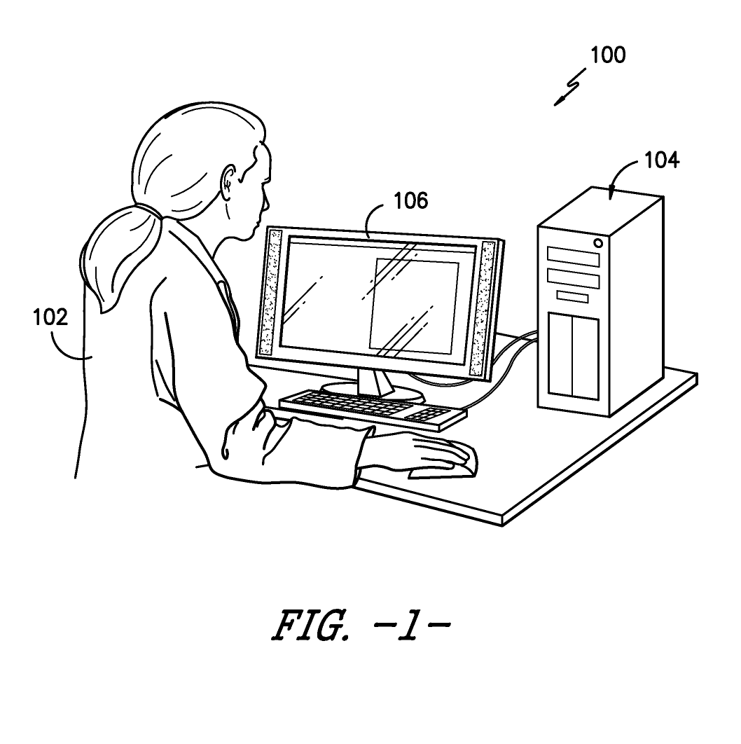

Referring now to FIG. 1, a simplified view of an example training environment 100 within which the present subject matter may be advantageously utilized is illustrated in accordance with aspects of the present subject matter. Specifically, in several embodiments, a healthcare learner or trainee 102 may utilize an ultrasound training device 104 to view and interact with a pre-recorded, moving ultrasound image of an internal body part(s), such as an internal organ. For example, as shown in FIG. 1, the moving ultrasound image may be displayed to the trainee 102 via a display 106 coupled to or otherwise associated with the training device 102.

In several embodiments, the moving ultrasound image displayed to the trainee 102 may correspond to an image frame loop having a plurality of consecutively ordered ultrasound image frames looped together to form a continuous moving image (i.e., similar to a video). As will be described below, as the trainee 102 is viewing the moving ultrasound image, the training device 104 may be configured to display various interface elements that allow the trainee 102 to pause the image frame loop at a given image frame as well as cycle backwards and forwards along the image frame loop to view image frames recorded prior to and after the paused image frame. The trainee 102 may then select the specific image frame that he/she believes is the best image for identifying, measuring or otherwise examining the organ component or other body part associated with the training exercise. For example, if the training exercise is associated with providing a measurement of a specific organ component, the trainee 102 may be asked to identify the particular image frame contained within the image frame loop that provides the best image for measuring such organ component.

In the illustrated embodiment, the ultrasound training device 104 is shown as a desktop computer. However, in other embodiments, the training device 104 may correspond to any other suitable processor-based device having a display 106 integrated therein or coupled thereto. For example, in other embodiments, the training device 104 may correspond to a laptop, a tablet, a smartphone and/or any other suitable computing device.

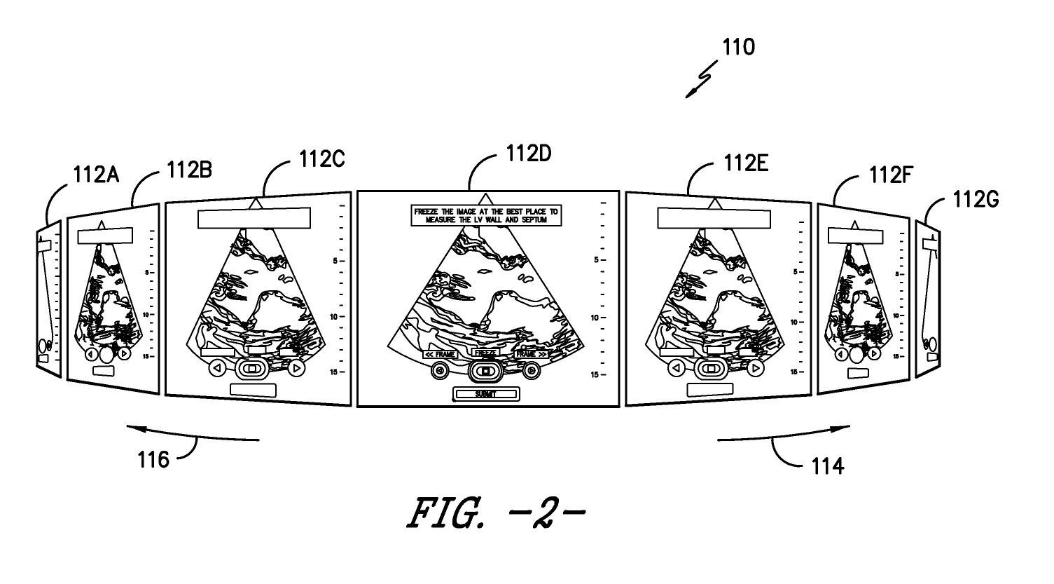

Referring now to FIG. 2, an example view of an image frame loop 110 associated a given moving ultrasound image is illustrated in accordance with aspects of the present subject matter. As shown, the image frame loop 110 may include a plurality of image frames 112A-G, with each image frame 112 depicting a single ultrasound image recoded during an actual ultrasound examination. By arranging the image frames 112 within the image frame loop 110 in the order in which they were recorded, the image frame loop 110 may be viewed as a moving ultrasound image or video of the examined organ or other internal body part. For example, during an ultrasound examination of a heart, ultrasound images may be captured of the heart at the temporal sampling frequency associated with the corresponding ultrasound unit (e.g., every 15 to 20 milliseconds). The captured ultrasound images or frames may then be compiled into a corresponding image frame loop.

As will be described below, the system and method described herein may allow a trainee to navigate through the image frame loop 110 associated with a moving ultrasound image in order to identify the image frame(s) corresponding to the best ultrasound image(s) for performing the task associated with the current training exercise. Specifically, as the moving ultrasound image is being viewed, the trainee may pause or stop the moving image at a specific image frame within the image frame loop 110. For example, for the image frame loop 110 shown in FIG. 2, it may be assumed that the trainee stopped the moving ultrasound image such that the center image frame 112D is currently being displayed to the trainee. In such instance, the trainee may view the image frame 112D to determine if it provides an appropriate depiction of the internal body part to be examined (e.g., an acceptable image of an organ component to be measured). If such image frame 112D does not appear to be acceptable, the trainee may then cycle forwards or backwards through the image frame loop 110 in an attempt to find a different image frame containing a better depiction of the internal body part to be examined For instance, by cycling forward through the image frame loop 110 (e.g., in the direction indicated by arrow 114 in FIG. 2), the trainee may view image frames (e.g., frames 112E-G) depicting consecutive ultrasound images recorded after the previously displayed image frame 112D. Similarly, by cycling backwards through the image frame loop 110 (e.g., in the direction indicated by arrow 116 in FIG. 2), the trainee may view image frames (e.g., frames 112A-C) depicting consecutive ultrasound images recorded prior to the previously displayed image frame 112D.

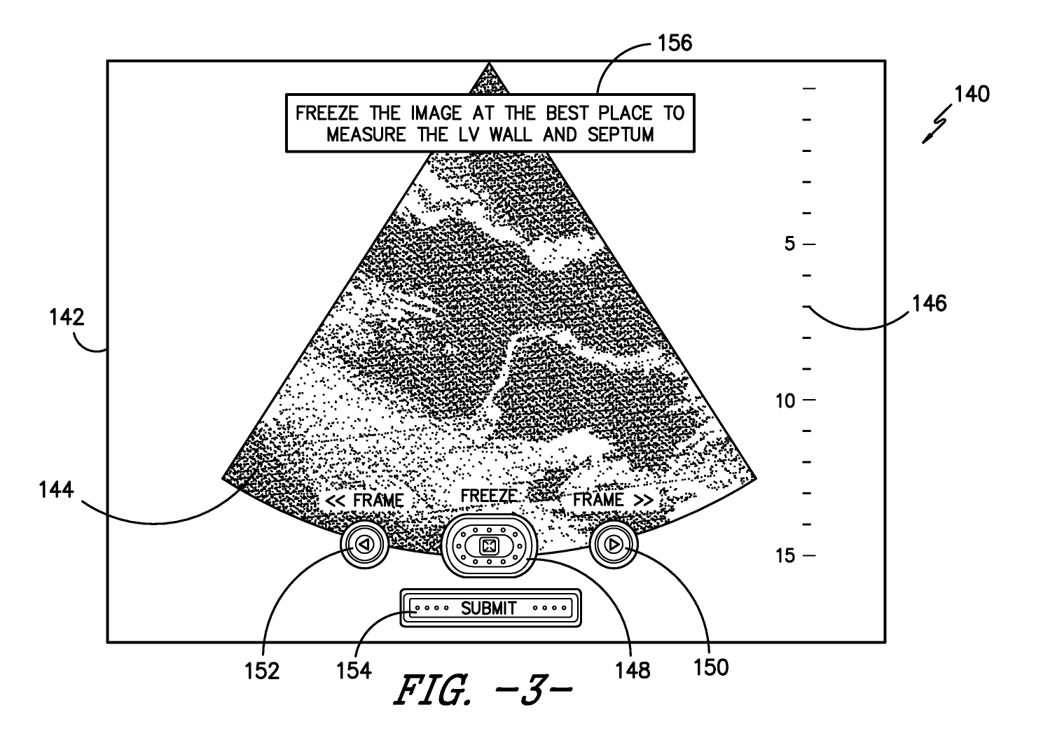

Referring now to FIG. 3, an example view of one embodiment of a suitable user interface 140 that may be displayed to a trainee viewing a moving ultrasound image as part of a computer-based, training methodology is illustrated in accordance with aspects of the present subject matter. As shown, the user interface 140 may include many elements that are the same as or similar to the elements typically provided within user interfaces used for clinical ultrasound units. For example, the user interface 140 may include a display window 142 within which moving ultrasound images 144 are displayed. In addition, the user interface 140 may include an embedded scale 146 providing information about the relative size(s) of the internal body part(s) depicted within the displayed image.

Moreover, in accordance with aspects of the present subject matter, the user interface 140 may include a plurality of interface elements 148, 150, 152, 154 displayed within or adjacent to the display window 142 that provide the trainee a means for inputting user inputs into the associated ultrasound training device 140. For example, as shown in FIG. 3, the user interface 140 may include a first interface element 148 associated with pausing or stopping the moving ultrasound image. Specifically, upon selection of the first interface element 148 by the trainee, the image frame loop associated with the moving ultrasound image may be paused at the image frame currently being displayed to the trainee.

Additionally, the user interface 140 may include one or more second interface elements 150, 152 associated with cycling through the image frame loop being displayed to the trainee. For example, as shown in FIG. 3, a forward interface element 150 may be provided on the user interface 140 that allows for the image frame loop to be cycled forward relative to the currently displayed image frame. Specifically, upon selection of the forward interface element 150 by the trainee, the image frame loop may be cycled forward such that the trainee is able to view image frames recoded subsequent to each previously viewed image frame. For instance, referring back to the image frame loop 110 shown in FIG. 2, selection of the forward interface element 150 may cause the image frame loop 110 to be cycled in the direction of arrow 114, thereby allowing the trainee to view the various image frames 112E-G recorded after the current displayed image frame 112D.

Similarly, as shown in FIG. 3, a backward interface element 152 may also be provided on the user interface 140 that allows for the image frame loop to be cycled backward relative to the currently displayed image frame. Specifically, upon selection of the backward interface element 152 by the trainee, the image frame loop may be cycled backward such that the trainee is able to view the image frames recoded prior to each previously viewed image frame. For instance, referring again to the image frame loop 110 shown in FIG. 2, selection of the backward interface element 150 may cause the image frame loop 110 to be cycled in the direction of arrow 116, thereby allowing the trainee to view the various image frames 112A-C recorded prior to the current displayed image frame 112D.

Referring still to FIG. 3, the user interface 140 may also include a third interface element 152 associated with submitting the image frame currently displayed within the display window 142 as the trainee's selection for the pending training exercise. Specifically, as indicated above, the trainee may be asked to identify an image frame that provides the best ultrasound image for performing a given examination task, such as measuring a parameter associated with an organ component. Thus, once the trainee identifies the specific image frame that he/she believes to be the most appropriate for performing the required examination task, the third interface element 154 may be selected to submit the currently displayed image frame as his/her selection. As will be described below, the ultrasound training device 104 may then be configured to assess the trainee's selection and provide the trainee feedback regarding his/her selected image frame.

Additionally, as shown in FIG. 3, in several embodiments, a message window 156 may also be displayed within the user interface 140 that provides the trainee with information associated with the current training exercise being conducted. In one embodiment, the message window 156 may be utilized to display a textual message indicating a particular training task to be performed. For example, as shown in FIG. 3, a textual message is being displayed within the display window 156 that reads: “Freeze the image at the best place to measure the LV wall and septum.” In such instance, the trainee may be required to navigate through an image frame loop associated with a moving ultrasound image of a heart (e.g., using the various interface elements 148, 150, 152) in order to find the image frame(s) contained within the image frame loop that provides the best ultrasound image(s) for measuring the identified organ components.

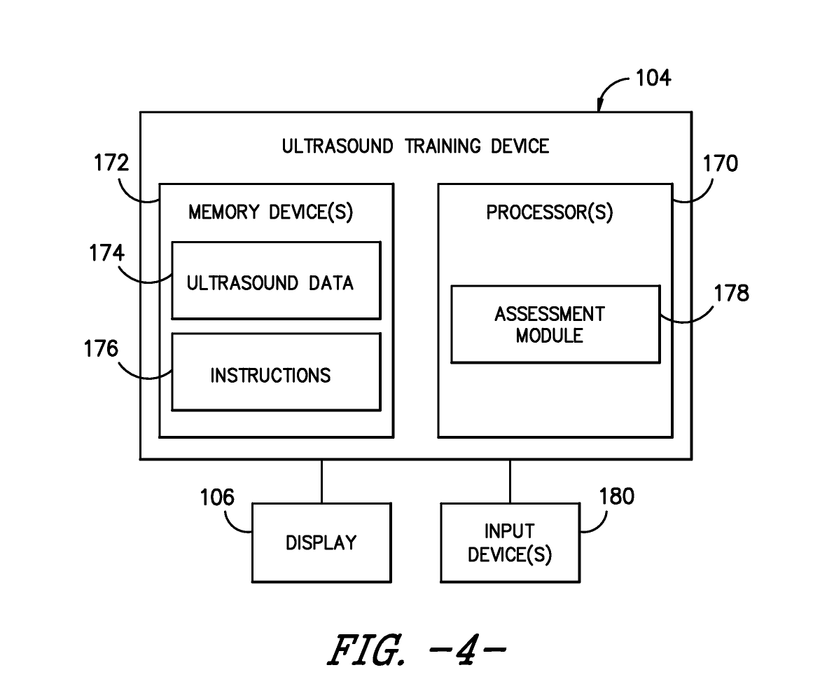

Referring now to FIG. 4, a schematic view of one embodiment of various components that may be included within or coupled to an ultrasound training device 104 used in connection with conducting ultrasonography training are illustrated in accordance with aspects of the present subject matter. Generally, the various components shown in FIG. 4 may include a combination of hardware, software and/or firmware elements, all of which either correspond to physical tangible apparatuses or which are embedded as instructions on a physical and tangible apparatus, such as a computer-readable storage medium. It should be appreciated that the components shown in FIG. 4 may be provided in different configurations and may be provided with different arrangements of direct and/or indirect physical and communicative links to perform the desired functionality of such components.

As indicated above, the training device 104 may generally correspond to any suitable processor-based device known in the art, such as a computing device or any suitable combination of computing devices. Thus, as shown in FIG. 4, the training device 104 may include one or more processor(s) 170 and associated memory device(s) 172 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 172 of the training device 104 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 172 may generally be configured to store suitable computer-readable instructions that, when implemented by the processor(s) 170, configure the training device 104 to perform various computer-implemented functions, such as facilitating the computer-based, ultrasonography training described herein.

As shown in FIG. 4, in several embodiments, the memory device(s) 172 associated with the training device 104 may be configured to store pre-recorded, ultrasound data 174 obtained during the performance of one or more actual ultrasound examinations. Specifically, in several embodiments, a plurality of different moving ultrasound images may be stored within the memory device(s) 172, with each moving ultrasound image being associated with a corresponding image frame loop containing a plurality of individual image frames. For example, one or more moving ultrasound images may be stored within the memory device(s) 122 for each internal body part typically examined via ultrasound, such as the heart, lungs, liver, kidneys, gallbladder, pancreas and/or any other suitable internal organ.

Additionally, in several embodiments, the memory device(s) 172 associated with the training device 120 may be configured to store instructions 176 that can be executed by the processor(s) 170. For example, as shown in FIG. 4, the instructions 176 stored within the memory device(s) 172 may be executed by the processor(s) 170 to implement an assessment module 178 configured to assess the image frame(s) selected by the trainee during each training exercise. Specifically, in several embodiments, for each training exercise provided for a given moving ultrasound image, one or more image frames contained within the associated image frame loop may be identified as the “correct” image frame(s) (i.e., the image frame(s) that should be selected by the trainee during the training exercise). In such an embodiment, upon the selection of an image frame by the trainee (e.g., using the third interface element 154 shown in FIG. 3), the assessment module 178 may be configured to determine whether the selected image frame corresponds to the correct image frame (or one of the correct image frames when multiples image frames have been identified as correct answers) associated with the training exercise currently being conducted. Thereafter, the assessment module 178 may be configured to provide feedback to the trainee regarding whether his/her selection was correct, such as by providing visual feedback displayed within the user interface 140 and/or by providing an audible alert. Such feedback may, in one embodiment, be provided immediately upon the selection of an image frame by a trainee. Alternatively, in instances in which the trainee is required to make multiple selections during the training exercise being conducted, the feedback may be provided at the end of the exercise (e.g., as a summary report).

It should be appreciated that, as used herein, the term “module” refers to computer logic utilized to provide desired functionality. Thus, a module may be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

Referring still to FIG. 4, the training device 104 may also be coupled to one or more output devices, such as a display 106. The display 106 may generally correspond to any suitable monitor, screen or other output device for presenting visual information to the trainee. For example, in one embodiment, the display 106 may simply correspond to a computer screen coupled to the training device 104. Alternatively, the display 106 may correspond to any other suitable display device, such as a light-emitting diode (LED) display, electroluminescent display (ELD), plasma display panel (PDP) or liquid crystal display (LCD), that is integrated within or coupled to the training device 104.

Additionally, as shown in FIG. 4, the training device 104 may also be coupled to one or more input devices 180 to allow the trainee to provide user inputs to the device 104. For example, in one embodiment, a touch screen may be integrated into or otherwise associated with the display 106 to allow the trainee to provide inputs to the training device 104 using his/her hand(s) and/or a stylus. In addition, or as an alternative thereto, a peripheral keyboard, mouse and/or any other suitable input device(s) may be coupled to the training device 104 to allow the trainee to provide user inputs. For example, a touchscreen, a keyboard and/or a mouse associated with the training device 104 may allow the trainee to select one or more of the various interface elements 148, 150, 152, 154 displayed within the user interface 140 while a training exercise is being conducted.

It should be appreciated that the various components shown in FIG. 4 are simply illustrated as one example of suitable components that may be included within or coupled to the training device 104. In other embodiments, the training device 104 may include or be coupled to any other suitable combination of components.

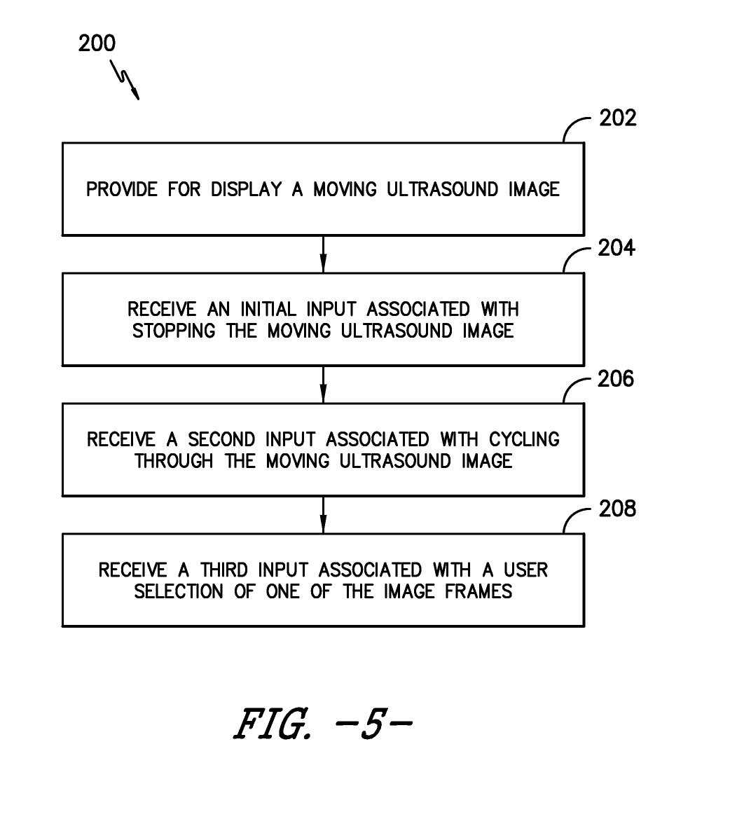

Referring now to FIG. 5, a flow diagram of one embodiment of a method 200 for conducting ultrasonography training using ultrasound loop control is illustrated in accordance with aspects of the present subject matter. It should be appreciated that, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 includes providing for display a moving ultrasound image of an internal body part. Specifically, as indicated above, the ultrasound training device 104 may include pre-recorded ultrasound data 174 stored within its memory device(s) 172, such as a plurality of pre-recorded moving ultrasound images associated with one or more internal body parts. In addition, the training device 104 may be communicatively coupled to display device 106. As such, the moving ultrasound image(s) stored within the device's memory may be transmitted to the display 106 for presentation to a trainee while a given training exercise is being conducted.

Additionally, at (204), the method 200 includes receiving an initial input from a user associated with stopping the moving ultrasound image. Specifically, as indicated above, the trainee may be allowed to pause or stop the moving ultrasound image at a given image frame contained within the associated image frame loop. For example, using the user interface 140 described above with reference to FIG. 3, the trainee may select the first interface element 148 displayed within the user interface 140 to stop the moving ultrasound image.

Referring still to FIG. 3, at (206), the method 200 includes receiving a second input associated with cycling through the moving ultrasound image. Specifically, as indicated above, the trainee may be allowed to cycle forwards or backwards through the image frame loop associated with the moving ultrasound image in order to view additional image frames contained within the image frame loop. For example, using the user interface 140 described above with reference to FIG. 3, the trainee may select the forward or backwards interface element 150, 152 displayed within the user interface 140 to cycle forward or backwards, respectively, through the image frame loop.

In addition, at (208), the method 200 includes receiving a third input associated with a selection of one of the image frames. Specifically, as indicated above, the trainee may be required to identify an image frame that provides the best ultrasound image for performing a given examination task, such as measuring a parameter associated with an organ component. Once the trainee identifies the specific image frame that he/she believes to be the most appropriate for performing the required examination task, he/she may then provide a suitable user input to the training device 104 to select such image frame. For example, using the user interface 140 described above with reference to FIG. 3, the trainee may select the third interface element 154 displayed within the user interface 140 to submit the currently displayed image frame as his/her selection.

It should be appreciated that, in addition to the various method elements shown in FIG. 5, the disclosed method 200 may also include additional method elements. For example, upon receipt of the third input (at (208), the method 200 may include assessing the trainee's selection using the assessment module 178 described above with reference to FIG. 4. In addition, the method 200 may include providing the trainee feedback regarding his/her selection.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for conducting ultrasonography training using ultrasound loop control, the method comprising:
providing for display, with a computing device, a moving ultrasound image of an internal body part, the moving ultrasound image associated with an image frame loop including a plurality of individual image frames;
receiving, with the computing device, an initial input from a user associated with stopping the moving ultrasound image at a current image frame of the image frame loop;
receiving, with the computing device, a second input associated with cycling forward or backwards through the image frame loop in order to provide additional image frames of the image frame loop for display to the user; and
receiving, with the computing device, a third input associated with a submission of one of the image frames as a selected image frame.

2. The method of claim 1, further comprising receiving the moving ultrasound image for storage with memory of the computing device.

3. The method of claim 1, wherein providing for display the moving ultrasound image comprises providing for display the moving ultrasound image within a user interface, the user interface including a plurality of interface elements configured to be selected by the user in order to provide user inputs to the computing device.

4. The method of claim 3, wherein the plurality of interface elements includes a first interface element associated with stopping the moving ultrasound image, at least one second interface element associated with cycling the image frame loop forward or backwards and a third interface element associated with submitting the selected image frame.

5. The method of claim 3, wherein the user interface further includes a message window including a textual message associated with a training exercise currently being conducted during the ultrasonography training.

6. The method of claim 1, further comprising cycling forward through the image frame loop upon receipt of the second input in order to provide for display image frames of the internal body part recorded after the current image frame.

7. The method of claim 1, further comprising cycling backwards through the image frame loop upon receipt of the second input in order to provide for display image frames of the internal body part recorded prior to the current image frame.

8. The method of claim 1, further comprising determining whether the selected image frame corresponds to a pre-defined correct image frame associated with a training exercise currently being conducted during the ultrasonography training.

9. A system for conducting ultrasonography training using ultrasound loop control, the system comprising:
a display;
a computing device coupled to the display, the computing device including a processor and associated memory, the memory storing instructions that, when implemented by the processor, configure the computing device to:
provide for display a moving ultrasound image of an internal body part, the moving ultrasound image associated with an image frame loop including a plurality of individual image frames;
receive an initial input from a user associated with stopping the moving ultrasound image at a current image frame of the image frame loop;
receive a second input associated with cycling forward or backwards through the image frame loop in order to provide additional image frames of the image frame loop for display to the user; and
receive a third input associated with a submission of one of the image frames as a selected image frame.

10. The system of claim 9, wherein the computing device is further configured to receive the moving ultrasound image for storage within the memory.

11. The system of claim 9, wherein the computing device is further configured generate a user interface within which the moving ultrasound image is displayed to the user, the user interface including a plurality of interface elements configured to be selected by the user in order to provide user inputs to the computing device.

12. The system of claim 11, wherein the plurality of interface elements includes a first interface element associated with stopping the moving ultrasound image, at least one second interface element associated with cycling the image frame loop forward or backwards and a third interface element associated with submitting the selected image frame.

13. The system of claim 11, wherein the user interface further includes a message window including a textual message associated with a training exercise currently being conducted during the ultrasonography training.

14. The system of claim 9, wherein the computing device is configured to cycle forward through the image frame loop upon receipt of the second input in order to provide for display image frames of the internal body part recorded after the current image frame.

15. The system of claim 9, wherein the computing device is configured to cycle backward through the image frame loop upon receipt of the second input in order to provide for display image frames of the internal body part recorded prior to the current image frame.

16. The system of claim 9, wherein the computing device is further configured to determine whether the selected image frame corresponds to a pre-defined correct image frame associated with a training exercise currently being conducted during the ultrasonography training
